(19) United States
(12) Patent Application Publication
(10) Pub. No.: US 2024/0319121 A1
(43) Pub. Date: Sep. 26, 2024

(54) ANALYSIS APPARATUS, ANALYSIS METHOD, AND ANALYSIS PROGRAM

(71) Applicant: Rigaku Corporation, Tokyo (JP)

(72) Inventor: Yoshiyasu ITO, Akishima-shi, Tokyo (JP)

(73) Assignee: Rigaku Corporation, Tokyo (JP)

(21) Appl. No.: 18/611,741

(22) Filed: Mar. 21, 2024

(30) Foreign Application Priority Data
Mar. 23, 2023 (JP) 2023-047057

(51) Int. Cl. G01N 23/201; G01N 23/20025

(52) U.S. Cl. CPC G01N 23/201; G01N 23/20025; G01N 2223/041; G01N 2223/054

(57) ABSTRACT

An analysis apparatus includes processing circuitry configured to store data of a scattering intensity measured by transmission of X-rays in one ω scan, perform coordinate conversion from the coordinate of the scattering vector to the coordinate of the tilt of the scattering body, with respect to a waveform based on the intensity of a specific diffraction point on the two-direction components, specify a peak position of the waveform of the intensity with respect to the coordinate of the tilt applied the coordinate conversion, and calculate a difference between the specified peak position and the peak position obtained on the assumption that the scattering body is not tilted from the direction perpendicular to the surface of the plate-shaped sample.

### CROSS-REFERENCE TO RELATED APPLICATION

This application claims priority from Japanese Patent Application No. 2023-047057, filed on Mar. 23, 2023, the entire contents of Japanese Patent Application No. 2023-047057 are incorporated herein by reference.

### BACKGROUND

### Technical Field

The present disclosure relates to an analysis apparatus, an analysis method, and an analysis program for analyzing a fine structure of a plate-shaped sample formed to have columnar scattering bodies that are long in a thickness direction and periodically arranged.

### Description of the Related Art

Conventionally, transmission small-angle X-ray scattering (tSAXS) has been performed in order to non-destructively and easily measure a pattern shape for a semiconductor device which is three-dimensionally miniaturized by a deep groove pattern.

Then, as an application of this measurement method, for the columnar scattering bodies periodically arranged in the plate-shaped sample, a method of accurately specifying the shape by taking much time for measurement and analysis assuming a complex shape model with high adaptability (see Patent Document 1) and a method of measuring in a short time with low accuracy on the assumption of a simple shape model (see Patent Document 2) is known. In addition, a method of calculating the tilt of a scattering body from a measurement result obtained by scanning in two directions without a shape model has been proposed (see Patent Document 3).

### PATENT DOCUMENT

Patent Document 1: JP-U.S. Pat. No. 7,100,897
Patent Document 2: JP-U.S. Pat. No. 7,168,985
Patent Document 3: International Publication No. 2020/028412

### SUMMARY

In the actual inspection process of semiconductors, there occurs needs not only for analysis of complex shapes in which the method described in Patent Document 1 is effective. For example, only the tilt of the columnar scattering body with respect to the sample surface, there is a scene to be measured in a short time while maintaining the accuracy. The techniques described in Patent Documents 2 and 3 are characterized by simplicity and can meet this need to some extent. However, it is difficult to complete the measurement and analysis in a short time while measuring the tilt of the columnar scattering body by the two-direction components with high accuracy.

The present disclosure has been made in view of such circumstances, and exemplary embodiments of the present disclosure include an analysis apparatus, an analysis method, and an analysis program capable of measuring only the two-direction components of the tilt of the columnar scattering bodies periodically arranged in a plate-shaped sample at high speed with high accuracy.
(1) In an exemplary embodiment, the analysis apparatus of the present disclosure is an analysis apparatus for analyzing a fine structure of a plate-shaped sample formed to have columnar scattering bodies that are long in a thickness direction and periodically arranged, comprising a measurement data storing section for storing data of a scattering intensity from the plate-shaped sample measured by transmission of X-rays in one ω scan, a coordinate conversion section for performing coordinate conversion from the coordinate of the scattering vector to the coordinate of the tilt of the scattering body, with respect to a waveform based on the intensity of a specific diffraction point on the two-direction components, using the data of the measured scattering intensity, a peak position specifying section for specifying a peak position of the waveform of the intensity with respect to the coordinate of the tilt applied the coordinate conversion, and a tilt calculating section for r calculating the difference between the specified peak position and the peak position obtained on the assumption that the scattering body is not tilted from the direction perpendicular to the surface of the plate-shaped sample, on the two-direction components of the tilt of the scattering body.
(2) Further, in the analysis apparatus according to (1), the coordinate conversion section performs the coordinate conversion to the coordinate of the tilt of the scattering body on at least one of the two-direction components, by a single analysis using a diffraction point at which one of the two-direction components of the scattering vectors is 0.
(3) Further, in the analysis apparatus according to (1), the coordinate converting section performs the coordinate conversion to the coordinate of the tilt of the scattering body on the two-direction components, by a loop analysis using a diffraction point where none of the two-direction components of the scattering vectors is not 0.
(4) Further, in the analysis apparatus according to any one of (1) to (3), the two-direction components correspond to components in X direction and along with the unit cell and Y direction orthogonal to the X direction, both of the X and Y directions being parallel to the surface of the plate-shaped sample.
(5) Further, in the analysis apparatus according to any one of (1) to (3), the two-direction components correspond to components in a₀ direction and being the scanning direction of the ω-scan and a₁ direction orthogonal to a₀ direction, both of the a₀ and a₁ directions being parallel to the surface of the plate-shaped sample.
(6) Further, in the analysis apparatus according to any one of (1) to (5), the coordinate conversion section uses a waveform integrated over a plurality of diffraction points as a waveform based on an intensity of a two-direction components of the specific diffraction point.
(7) Further, the analysis method of the present disclosure is an analysis method for a fine structure of a plate-shaped sample formed to have columnar scattering bodies that are long in a thickness direction and periodically arranged, comprising the following steps of preparing data of a scattering intensity from the plate-shaped sample measured by transmission of X-rays in one ω scan, performing coordinate conversion from the coordinate of the scattering vector to the coordinate of the tilt of the scattering body, with respect to a waveform based on the intensity of a specific diffraction point on the two-direction components, using the data of the measured scattering intensity, specifying a peak position of the waveform of the intensity with respect to the coordinate of the tilt applied the coordinate conversion, and calculating the difference between the specified peak position and the peak position obtained on the assumption that the scattering body is not tilted from the direction perpendicular to the surface of the plate-shaped sample, on the two-direction components of the tilt of the scattering body.
(8) Further, the analysis program of the present disclosure is an analysis program for analyzing a fine structure of a plate-shaped sample formed to have columnar scattering bodies that are long in a thickness direction and periodically arranged, causing a computer to execute the following processes of preparing data of a scattering intensity from the plate-shaped sample measured by transmission of X-rays in one ω scan, performing coordinate conversion from the coordinate of the scattering vector to the coordinate of the tilt of the scattering body, with respect to a waveform based on the intensity of a specific diffraction point on the two-direction components, using the data of the measured scattering intensity, specifying a peak position of the waveform of the intensity with respect to the coordinate of the tilt applied the coordinate conversion, and calculating the difference between the specified peak position and the peak position obtained on the assumption that the scattering body is not tilted from the direction perpendicular to the surface of the plate-shaped sample, on the two-direction components of the tilt of the scattering body.

### BRIEF DESCRIPTION OF THE DRAWINGS

FIG. 1 illustrates a perspective view showing a measuring system of a transmission CD-SAXS.

FIGS. 2A and 2B illustrate diagrams showing a unit cell of a hole pattern and a relationship between a silicon wafer and a lattice vector, respectively.

FIG. 3 illustrates a graph of a scatter intensity profile for Q_{Z} of diffraction points.

FIG. 4 illustrates a block diagram showing a measurement system of the present disclosure.

FIG. 5 illustrates a plan view showing a configuration of a measurement apparatus.

FIG. 6 illustrates a flowchart showing a measurement and analysis procedure of the present disclosure.

FIGS. 7A and 7B illustrate flow charts showing single and looped analyses, respectively.

FIG. 8 illustrates a graph showing Q_{Z} waveforms based on the intensity for ex of diffractive points with Q_{Y}=0 nm⁻¹.

FIG. 9 illustrates a graph showing Q_{Z} waveforms based on the intensity for OY of diffractive points with Q_{X}=0 nm⁻¹.

FIG. 10 illustrates a graph showing Q_{Z} waveforms based on the intensity for ex of diffraction points with Q_{X}≠0 nm⁻¹.

FIG. 11 illustrates a graph showing Q_{Z} waveforms based on the intensity for θ_{Y} of diffraction points with Q_{Y}≠0 nm⁻¹.

FIGS. 12A and 12B illustrate a graph and a table showing optimize of XY components of the tilt, respectively.

FIGS. 13A and 13B illustrate a diffraction image subject to a single analysis of ex and a graph showing Q_{Z} waveforms based on the intensity for OX of diffraction points with Q_{Y}=0 nm⁻¹, respectively.

FIGS. 14A and 14B illustrate a diffraction image subject to a single analysis of OY and a graph showing Q_{Z} waveforms based on the intensity for OY of diffraction points with Q_{X}=0 nm⁻¹, respectively.

FIGS. 15A and 15B illustrate a diffraction image subject to a loop analysis and a graph showing Q_{Z} waveforms based on the intensity for θ_{X} of diffraction points, respectively.

FIGS. 16A and 16B illustrate a diffraction image subject to a loop analysis and a graph showing Q_{Z} waveforms based on the intensity for θ_{Y} of diffraction points, respectively.

FIGS. 17A and 17B illustrate a diffraction image subject to a single analysis of ex and a graph showing Q_{Z} waveforms based on the intensity for OX of diffraction points with Q_{Y}=0 nm⁻¹, respectively.

FIG. 18 illustrates a diffracted image subject to a single analysis of θ_{Y}.

FIGS. 19A and 19B illustrate a diffraction image subject to a loop analysis and a graph showing Q_{Z} waveforms based on the intensity for θ_{X} of diffraction points, respectively.

FIGS. 20A and 20B illustrate a diffraction image subject to a loop analysis and a graph showing Q_{Z} waveforms based on the intensity for θ_{Y} of diffraction points, respectively.

FIG. 21 illustrates a diffraction image subject to a single analysis.

FIG. 22 illustrates a diffraction image subject to a single analysis and a graph showing Q_{Z} waveforms based on the intensity for a₀ of diffraction points, respectively.

FIG. 23 illustrates a diffraction image subject to a single analysis and a graph showing Q_{Z} waveforms based on the intensity for a₁ of diffraction points, respectively.

FIG. 24 illustrates a diffraction image subject to a loop analysis and a graph showing Q_{Z} waveforms based on the intensity for a₀ of diffraction points, respectively.

FIG. 25 illustrates a diffraction image subject to a loop analysis and a graph showing Q_{Z} waveforms based on the intensity for a₁ of diffraction points, respectively.

### DETAILED DESCRIPTION

Next, embodiments of the present disclosure are described with reference to the drawings. To facilitate understanding of the description, the same reference numerals are assigned to the same components in the respective drawings, and duplicate descriptions are omitted.

### First Embodiment

### [Transmittance CD-SAXS]

The present disclosure describes analyzing a fine structure of a plate-shaped sample formed to have columnar scattering bodies that are long in a thickness direction and periodically arranged and is applicable for calculating a tilt of the scattering body in the sample by a transmission CD-SAXS that can be performed at a laboratory level. In particular, the present disclosure describes analyzing shapes of semiconductor devices having fine processing patterns with deep grooves, such as three-dimensional NAND and DRAM. The present disclosure is effective for non-destructively and conveniently measuring fine patterns with deep grooves having a very large aspect ratio and is suitable for analyzing a structure embedded in a substrate. Measurement of the shape of the deep groove pattern is highly demanded even for three-dimensional semiconductor devices in recent years, and the present disclosure can greatly contribute to in-line measurement of the three-dimensional semiconductor device.

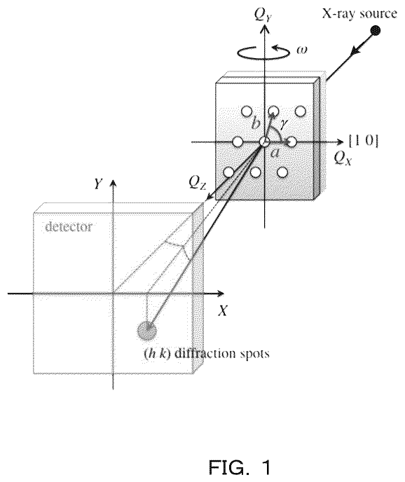

FIG. 1 is a perspective view showing a measuring system of a transmission CD-SAXS. In a transmission CD-SAXS, sample rotation (w rotation) is performed with respect to an orientation in which X-rays are incident perpendicularly to the sample surface, and the sample rotation angle dependency of the integrated intensity of the diffracted ray is measured. The purpose of rotating the sample is to change the scatter vector Q_{Z} to acquire depth-direction data.

### [Scattering Vector and Sample Structure]

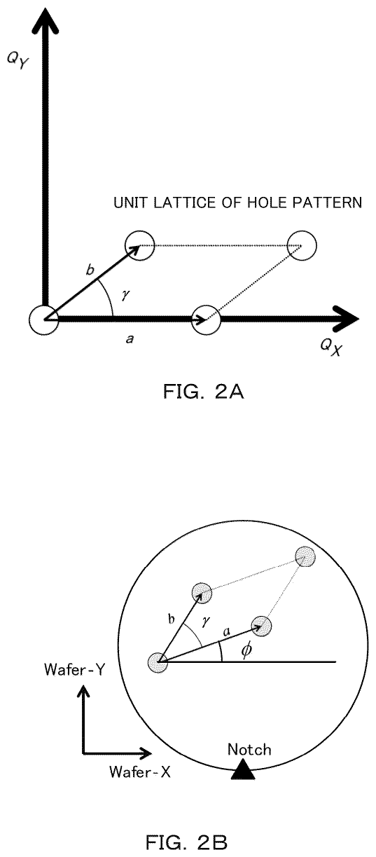

FIGS. 2A and 2B are diagrams showing a unit cell of a hole pattern and a relationship between a silicon wafer and a lattice vector, respectively. If there is a unit cell with lattice constants a and b and a lattice angle γ, the diffraction conditions of the diffraction index (h, k) are given using the scattering vector Q_{X}, Q_{Y} and Q_{Z}.

$$\{ \begin{matrix}{Q}_{X} = 2 π \frac{h}{a} \\ {Q}_{Y} = 2 π ( - \frac{h}{a tan γ} + \frac{k}{b sin γ} ) \\ {Q}_{Z} \approx - {Q}_{X} tan ω\end{matrix} \qquad ( 1 )$$

Q_{X} can be defined as a scattering vector in a direction parallel to the a-axis of the unit cell, and Q_{Y} can be defined as a scattering vector in a direction orthogonal to Q_{X}.

For example, in the case of a silicon wafer sample, a mark called a notch is provided to the sample, and the measurement is performed after XY directions of the sample are often aligned to the directions of the scatter vectors Q_{X} and Q_{Y}. Hereinafter, basically, XY directions of the sample are assumed to be same as the directions of the scattered vector Q_{X} and Q_{Y}.

When the a-axis is rotated by φ with respect to the notch, the tilt angle (θ_{WX}, θ_{WY}) of the wafer reference can be calculated as follows.

$$\begin{matrix}{θ}_{WX} = {θ}_{X} cos ϕ - {θ}_{Y} sin ϕ \\ {θ}_{WY} = {θ}_{X} sin ϕ + {θ}_{Y} cos ϕ\end{matrix} \qquad ( 2 )$$

### [Tilt Angle and Q_{Z} Waveform]

If the scattering body of the cylinder has a central axis in a direction perpendicular to the surface of the sample, the shape factor of the scattering body of the cylinder is expressed as:

$$F ( Q , {R}_{0} , H ) = 4 π {R}_{0} \frac{{J}_{1} ( {R}_{0} {Q}_{R} )}{{Q}_{R}} \times \frac{sin \frac{H}{2} {Q}_{Z}}{{Q}_{Z}} \qquad ( 3 )$$

In addition, the form factors of the cylindrical scattering bodies tilted by θ_{X} and OY in Q_{X} and Q_{Y} directions, respectively, with respect to the surface, are expressed as follows.

$$F ( Q , {R}_{0} , H , {θ}_{X} , {θ}_{Y} ) = 4 π {R}_{0} \frac{{J}_{1} ( {R}_{0} {Q}_{R} )}{{Q}_{R}} \times \frac{sin \frac{H}{2} ( {Q}_{X} tan {θ}_{X} + {Q}_{Y} tan {θ}_{Y} + {Q}_{Z} )}{{Q}_{X} tan {θ}_{X} + {Q}_{Y} tan {θ}_{Y} + {Q}_{Z}} \qquad ( 4 )$$

Considering the inside of the broken lines of the above formulas (2) and (3), when the scattering bodies are tilted by θ_{X} and θ_{Y} in Q_{X} and Q_{Y} directions, respectively, with respect to the surface of the sample, the wave form in Q_{Z} direction is moved in parallel to Q_{Z} direction by the following amounts.

$$Δ {Q}_{Z} = - {Q}_{X} tan {θ}_{X} - {Q}_{Y} tan {θ}_{Y} \qquad ( 5 )$$

That is, θ_{X} and θ_{Y} can be obtained by extracting the deviation of Q_{Z} waveforms for the respective diffraction points. When the deviation of Q_{Z} waveform is calculated, it is easy to calculate the deviation of the center position. In this way, it is possible to determine the tilt angle of two axes without a model and at high speed with one scan data.

The following formulas can be derived as expressions representing θ_{X} and θ_{Y}.

$${θ}_{X} = - {tan}^{- 1} ( \frac{{Q}_{Z} + {Q}_{Y} tan {θ}_{Y}}{{Q}_{X}} ) \qquad ( 6 )$$

$${θ}_{Y} = - {tan}^{- 1} ( \frac{{Q}_{Z} + {Q}_{X} tan {θ}_{X}}{{Q}_{Y}} ) \qquad ( 7 )$$

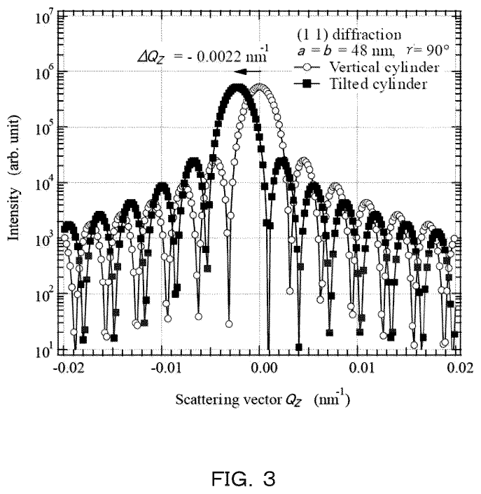

In fact, the positions of Q_{Z} waveforms differ between samples with and without a tilt in the scattering bodies. FIG. 3 is a graph of the scatter intensity profile for Q_{Z} of diffraction points of (11). The plot of the circles represents Q_{Z} waveform due to the cylindrical scattering bodies having the central axis perpendicular to the surface of the sample, and the plot of the squares represents Q_{Z} waveform due to the cylindrical scattering bodies having the central axis tilted from the direction perpendicular to the surface of the sample. In the embodiment shown in FIG. 3, the difference ΔQ_{Z} between Q_{Z} waveforms are 0.0022 nm⁻¹.

### [Configuration of Measurement System]

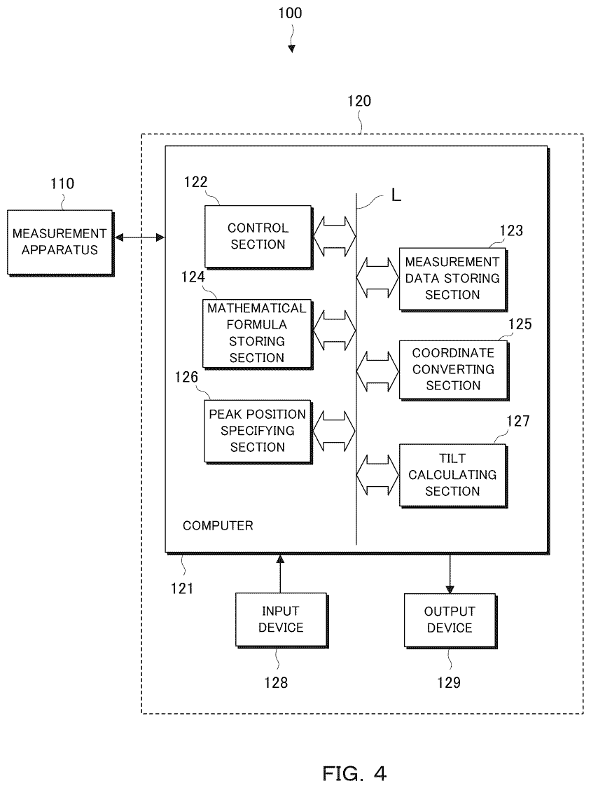

Next, the configuration of the measurement system 100 of the present disclosure is described. FIG. 4 is a block diagram showing the measurement system 100. The measurement system 100 comprises a measurement apparatus 110 and an analysis apparatus 120 and irradiates the plate-shaped sample with X-rays to enable measurement and analysis of a transmission CD-SAXS by the measurement of the scattered intensity. The analysis apparatus 120 controls the measurement apparatus 110, manages the measurement data together with the control data, and enables analysis of the data. A specific configuration is described below.

### [Configuration of Measurement Apparatus]

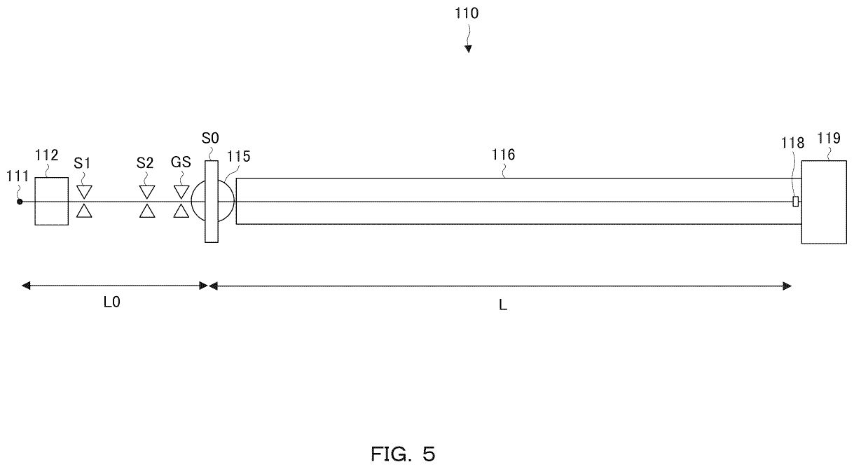

FIG. 5 is a plan view showing a configuration of the measurement apparatus 110. The measurement apparatus 110 comprises an X-ray source 111, a mirror 112, a slit S1, S2 and GS, a sample stage 115, a vacuum path 116, a beam stopper 118, and a detector 119. For example, the distance LO from the X-ray source 111 to the sample S0 and the camera length L can be set to 1000 mm and 3000 mm, respectively.

Mokα can be used as the X-ray source 111. The mirror 112 disperses the X-rays emitted from the X-ray source 111 and irradiates the dispersed X-rays toward the sample S0. The slits S1 and S2 are formed of members capable of shielding X-rays and configures slit parts for narrowing the dispersed X-rays. With such a configuration, X-rays can be irradiated at a plurality of rotational angles ω which are close to the direction perpendicular to the surface of the plate-shaped sample S0. For example, specific angles in the range of −10° to 10° C. an be selected for the plurality of rotation angles w. The slit GS can limit the spot-size of the X-rays on the surface of the sample to a few tens of micrometers or less. Basically, the beam size is determined by the slit S1 and S2, and the parasitic scatterings generated in the slit S1 and S2 are removed by using the slit GS. However, if very small spots are to be generated, the beams can be made smaller with the slit GS.

The sample stage 115 supports the sample S0 on the table, and the orientation of the plate-shaped sample S0 can be adjusted by a driving mechanism under the control of the analysis apparatus 120. Specifically, not only the ω rotation angle around Q_{Y} shown in FIG. 1 but also the x rotation angle and the φ rotation angle can be adjusted. By such adjusting, it is possible to change the incident angle of the dispersed X-ray into the sample S0 and measure the scattered intensity according to the diffraction angle.

The sample S0 is formed in a plate shape, and the scattering bodies are periodically arranged in directions parallel to the main surface of the sample. An example of the scattering body is a hole. That is, a typical sample is a substrate of a silicon wafer, and in that case the scattering bodies are holes formed by etching. It is important that the higher the integration degree, the more accurate hole shape formation can be confirmed with respect to the specification.

The scattering body is not limited to the above-described hole and may be a pillar. That is, the present disclosure can also be applied to a sample of a silicon substrate in which cylinders are periodically formed on the surface. Alternatively, a sample in which a line pattern (space pattern) such as a long molecular arrangement is formed may be measured.

The vacuum path 116 maintains the path of the scattered beam at vacuum to prevent attenuation of the beam while securing the camera length long. The beam stopper 118 absorbs the direct beam. The detector 119 is, for example, a two-dimensional detector of a semiconductor capable of moving on a circle with a center of the sample position and is capable of detecting the scattering intensity of X-rays. The measurement apparatus 110 and the analysis apparatus 120 are connected to each other, and the detected scattering intensity data is transmitted to the analysis apparatus 120.

In an exemplary embodiment, the measurement apparatus 110 comprises a laser light source and a detector for reflected light. It is possible to adjust the orientation of the plate-shaped sample so that the surface of the plate-shaped sample is perpendicular to the incident direction of the X-rays using the reflection of the laser beam. The orientation adjusted in this way can be used as a reference, where ω=χ=0°.

### [Configuration of Analysis Apparatus]

The analysis apparatus 120 comprises, for example, a PC including memories and processors and can execute respective processes by executing programs. By processing the measurement data acquired from the measurement apparatus 110, it is possible to analyze the fine structure of a plate-shaped sample formed by periodically arranging scattering bodies long in the thickness direction.

The analysis apparatus 120 comprises a computer 121, an input device 128, and an output device 129. Further, the computer 121 comprises a measurement control section 122, a measurement data storing section 123, a mathematical formula storing section 124, a coordinate conversion section 125, a peak position specifying section 126, and a tilt calculating section 127. The computer 121 may be a PC terminal or a server on a cloud. Each section can transmit and receive information via the control bus L.

The measurement control section 122 controls the measurement apparatus 110 and manages control data and measurement data. For example, the measurement control section 122 controls the sample stage 115 by a driving mechanism to adjust the orientation of the sample S0.

The measurement data storing section 123 stores the measured X-ray intensity data. The measured intensity data is measured at an ω rotation angle in the vicinity of a direction perpendicular to the surface of the plate-shaped sample, and the X-ray incident from the back side of the plate-shaped sample is scattered by the scattering bodies on the front side of the plate-shaped sample and detected by the detector. It is sufficient to have data measured in a single ω scan. The mathematical formula storing section 124 stores mathematical formulas for fitting to the scattering intensity and coordinate conversion.

The coordinate conversion section 125 converts the coordinate of the scattering vector into the coordinate of the tilt of the scattering body with respect to the waveform based on the intensity of the specific diffraction point on the two-direction components, using the data of the measured scattering intensity.

The coordinate converting section 125 first acquires Q_{Z} waveforms of the respective diffraction points. Then, a waveform integrated over a plurality of diffraction points can be used as a waveform based on the intensity of a specific diffraction point on the two-direction components. Thus, the peak position can be specified with high accuracy.

The coordinate converting section 125 performs a single analysis or a loop analysis according to the user's selection and the presence or absence of a Q_{Z} waveform. The details of single and loop analyses are described below. The coordinate converting section 125 selects diffraction points to be subjected to single analysis or loop analysis by user selection or automatically. In a single analysis of ex, diffraction points with Q_{Y}=0 nm⁻¹ are selected, and in a single analysis of Or, diffraction points with Q_{X}=0 nm⁻¹ are selected. In the looped analysis, Q_{X}≠0 nm⁻¹ and Q_{X}≠0 nm⁻¹ diffraction points are selected. In both cases, for example, a diffraction point having a large intensity can be selected. The analysis apparatus 120 can perform both single analysis and loop analysis but may be an apparatus capable of performing only one of them.

If the single analysis has been performed, the coordinate converting section performs coordinate conversion to the coordinate of the tilt of the scattering body on at least one of the two-direction components using the diffraction points where one of the two-direction components in the coordinate of the scattering vector on is 0. As a result, coordinate conversion can be performed in a single time. For example, the two-direction components are components in two directions parallel to the surface of the plate-shaped sample. For example, the two-direction components are components in directions parallel to the surface of the plate-shaped sample and in the x-direction along with the unit cell and the y-direction orthogonal to the x-direction. Thus, the tilt angle of the two components can be easily calculated for the sample in which the orientation of the unit cell is recognized.

If the loop analysis is performed, the coordinate converting section 125, by loop analysis using diffraction points in which none of the two-direction components in the coordinate of the scattering vector are not 0, performs coordinate conversion to the coordinate of the tilt of the scattering body on the two-direction component. As a result, the tilt angle can be calculated with high accuracy using many diffraction points.

The peak position specifying section 126 specifies the peak position with respect to Q_{Z} waveform which is the waveform of the intensity with respect to the coordinate of the tilt after the coordinate conversion.

The peak position specifying section 126 acquires a mathematical formula for fitting from the mathematical formula storing section 124 and calculates a peak position of Q_{Z} waveform by fitting. The peak position specifying section 126 checks whether or not the fitting performed is optimal and changes the parameters until the fitting is optimal. θ_{X} and θ_{Y} at the peak of the resulting waveform converge to the X component T_{X} and Y component T_{Y} of the tilt of the scattering body, respectively.

The tilt calculating section 127 calculates, as the tilt of the scattering bodies on two-direction components, a difference between the specified peak position and the peak position obtained by assuming that the scattering bodies are not tilted from a direction perpendicular to the surface of the plate-shaped sample. As a result, the measurement and analysis time can be shortened, and the tilt angle on the two-direction components can be calculated with high analysis accuracy.

The input device 128 is, for example, a keyboard or a mouse and receives an input to the computer 121. The user can select the type of analysis and the diffraction point via the input device 128. The output device 129 is, for example, a display and outputs a screen for selection and an analysis result.

### [Measurement and Analysis Methods]

### (Overall Flow)

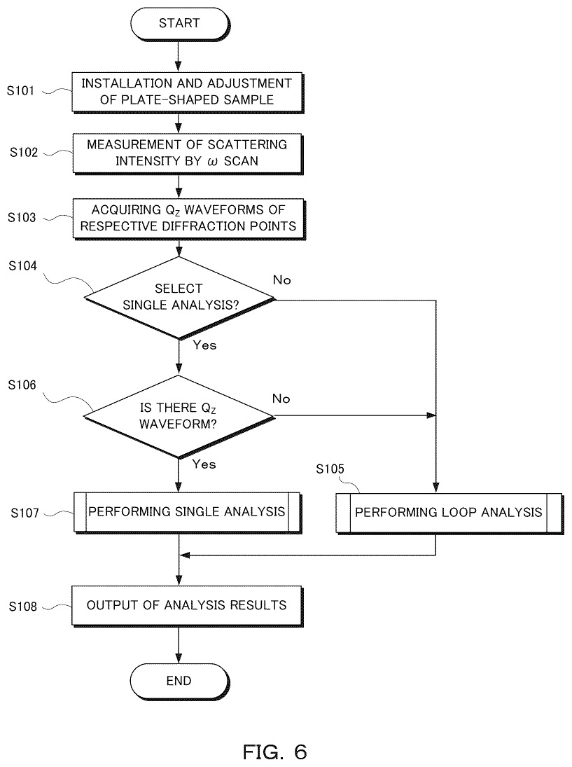

Next, a measurement and analysis method using the configuration of the above-described system is described. FIG. 6 is a flowchart showing a measurement and analysis procedure. As shown in FIG. 6, first, a plate-shaped sample is placed, and the position is adjusted (step S101). Then, the scattered intensity is measured by one ω-scan (step S102). So far is the measurement.

In the analysis, first, Q_{Z} waveforms of the respective diffraction points are acquired on the basis of the measured data (step S103). Then, a selection of the user is accepted, and it is determined whether or not a single analysis for independently analyzing Q_{X} and Q_{Y} is selected (step S104). If a single analysis is not selected (=if a loop analysis is selected), a loop analysis is performed (step S105) and the process proceeds to step S108.

If a single analysis is selected, it is determined whether a Q_{Z} waveform exists with both Q_{X}=0 nm⁻¹ and Q_{Y}=O nm⁻¹. If it does not exist, the process proceeds to step S105. If it exists, a single analysis is performed (step S107). Then, the analysis result is output (step S108), and the series of steps is ended.

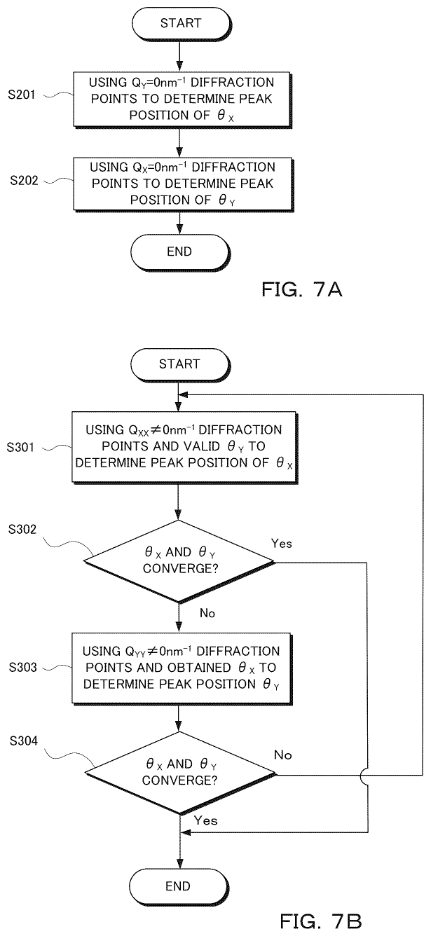

FIGS. 7A and 7B are flow charts showing single and looped analyses, respectively.

As shown in FIG. 7A, in the single analysis, diffractive points with Q_{Y}=0 nm⁻¹ are used to determine the peak position of OX as the X component of the tilt angle (step S201). Then, the peak position of OY is determined as the Y component of the tilt angle by using the diffraction points with Q_{X}=0 nm⁻¹ (step S202), and the single analysis is ended.

Further, as shown in FIG. 7B, in the loop-analysis, the peak position of θ_{X} is determined by using a valid θ_{Y} and the diffraction points with Q_{X}≠0 nm⁻¹ (step S301). Then, it is determined whether or not ex and OY have converged (step S302). The convergence determination can be performed, for example, as to whether or not the difference or the variation of ex and OY are equal to or less than a threshold. If they have converged, the loop analysis is ended. If they have not converged, the process proceeds to step S303.

Next, the peak position of OY is determined using the determined ex and the diffraction points with Q_{Y}≠0 nm⁻¹ (step S303). Then, it is determined whether or not ex and OY have converged (step S304). If they have converged, the loop analysis is ended. If they have not converged, the process proceeds to step S301. Thus, OX and OY which finally converged are the X component and the Y component of the tilt angle, respectively. In any of the above analyses, there is an order in the analysis of OX and Or, but the order may be reversed. Further, each process in the above analysis can be performed by executing a program.

### (Single Analysis)

The details of the single analysis are described by way of example. The single analysis is an analysis method in which a tilt angle can be specified by using a mathematical formula in a single time when a Q_{Z} waveform is present with both Q_{X}=0 nm⁻¹ and Q_{Y}=0 nm⁻¹. Here, θ_{X} and θ_{Y} can be calculated independently.

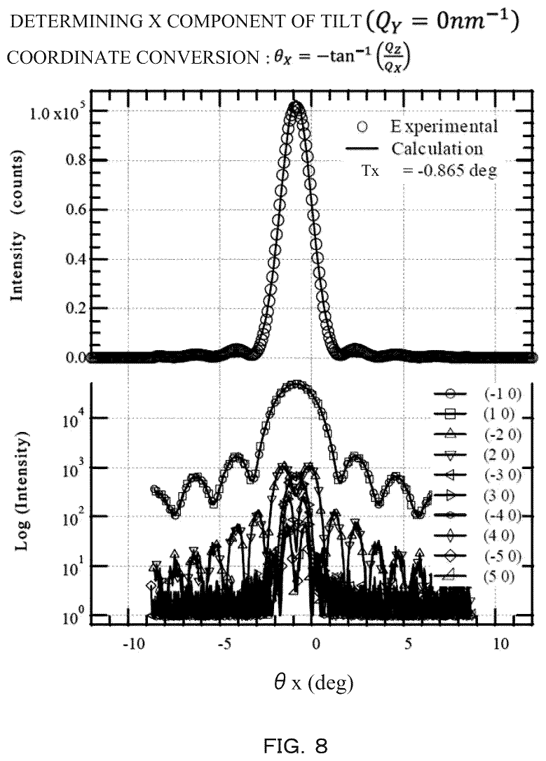

In the single analysis, the horizontal axis of Q_{Z} waveform is first applied a coordinate conversion into the ex using only the diffractive points with Q_{Y}=0 nm⁻¹ using the following formula. FIG. 8 is a graph showing Q_{Z} waveforms based on the intensity for ex of diffractive points with Q_{Y}=0 nm⁻¹.

$${θ}_{X} = - {tan}^{- 1} ( \frac{{Q}_{Z}}{{Q}_{X}} ) \qquad ( 8 )$$

The intensities are integrated on the horizontal axis Ox with respect to the plurality of waveforms shown on the lower side of FIG. 8, and the peak position on the X component of the tilt angle is determined by peak search with respect to the waveform indicating the integration on the upper side of FIG. 8.

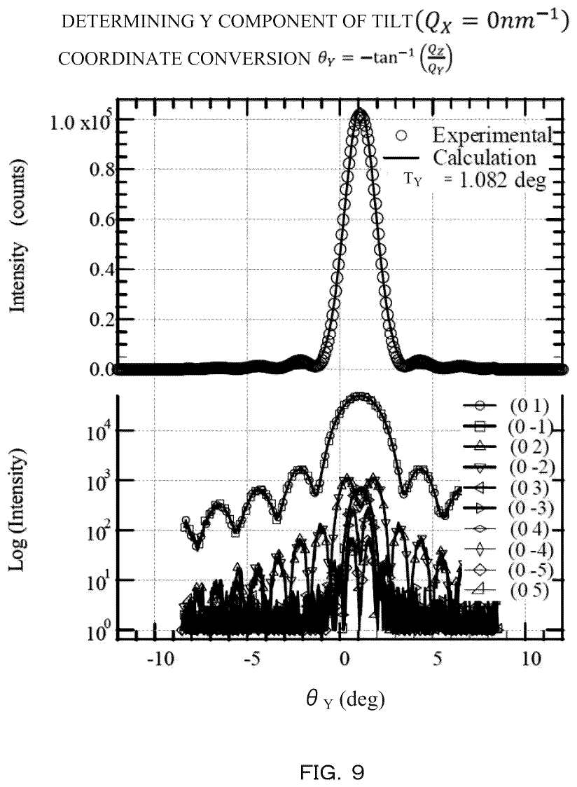

On the other hand, for Q_{Z} waveform, only the diffractive points with Q_{X}=0 nm⁻¹ are used, and the horizontal axis of Q_{Z} waveform is applied a coordinate conversion into θ_{Y} using the following formula. FIG. 9 is a graph showing waveforms based on the intensity for θ_{Y} of diffractive points with Q_{X}=0 nm⁻¹.

$${θ}_{Y} = - {tan}^{- 1} ( \frac{{Q}_{Z}}{{Q}_{Y}} ) \qquad ( 9 )$$

The Intensities are integrated on the horizontal axis θ_{Y} with respect to a plurality of waveforms shown in the lower side of FIG. 9, and a peak position as a Y-component of the tilt angle is determined by peak search with respect to the waveform showing the integration on the upper side of FIG. 9.

In such a single analysis, Q_{X} is not correlated with Q_{Y}, and θ_{X} and θ_{Y} can be independently calculated. On the other hand, diffraction points respectively with Q_{X}=0 nm⁻¹ and Q_{Y}=0 nm⁻¹ needs to be prepared as diffraction points for use in analysis.

### (Loop Analysis)

The loop analysis is an analysis that can specify the tilt angle by repeatedly calculating ex and OY and converging the numerical value when there is no Q_{Z} waveform with Q_{X}=0 nm⁻¹ or Q_{Y}=0 nm⁻¹. The loop analysis is described by way of example.

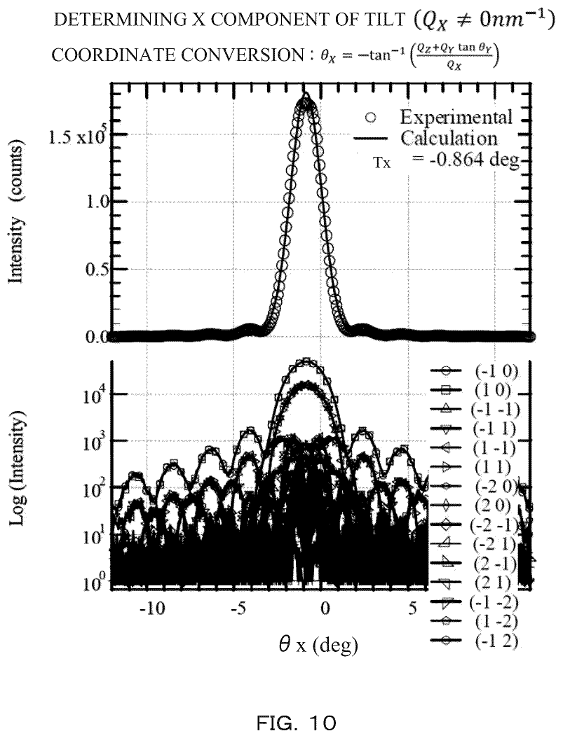

First, θ_{Y} is given a valid value as the initial value. For example, θ_{Y}=0. Further, using diffractive points with Q_{X}≠0 nm⁻¹, the horizontal axis of Q_{Z} waveform is converted into OX by formula (5). FIG. 10 is a graph showing Q_{Z} waveforms based on the intensity for ex of diffraction points with Q_{X}≠0 nm⁻¹. The intensities are integrated on the horizontal axis ex with respect to a plurality of waveforms shown on the lower side of FIG. 10, and the peak position of ex is determined by peak searching with respect to the waveform showing the integration on the upper side of FIG. 10.

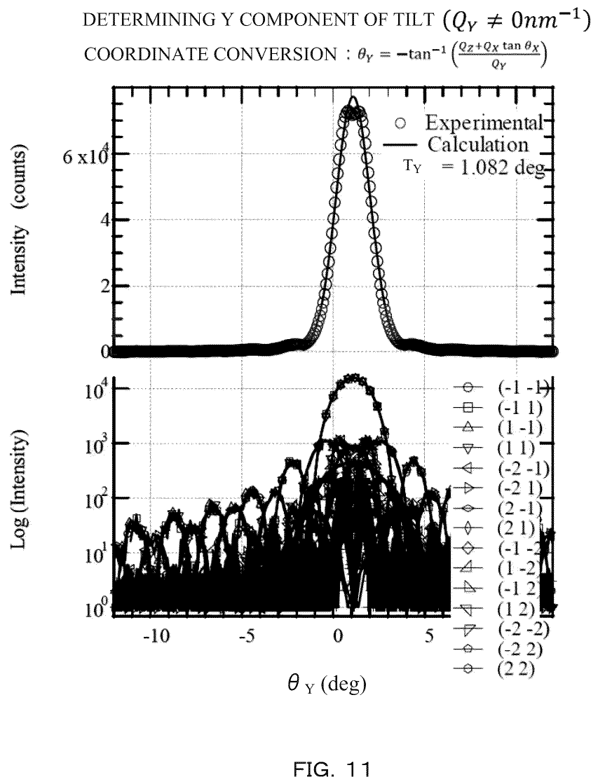

A numerical value of the determined peak-position is then given to ex. Further, using diffractive points with Q_{Y}≠0 nm⁻¹, the horizontal axis of Q_{Z} waveform is converted into θ_{Y} by formula (6). FIG. 11 is a graph showing Q_{Z} waveforms based on the intensity for θ_{Y} of diffraction points with Q_{Y} #0 nm⁻¹. The Intensities are integrated on the horizontal axis θ_{Y} with respect to a plurality of waveforms shown on the lower side of FIG. 11, and the peak position of θ_{Y} is determined by peak search with respect to the waveform showing the integration on the upper side of FIG. 11. The determination of the peak position of ex and θ_{Y} is repeated until the peak position of θ_{X} and θ_{Y} converges.

Q_{Z} waveform with Q_{Y}=0 nm⁻¹ or Q_{X}=0 nm⁻¹ may not be present if the measurement is performed under the condition that the rotational axis is same as Q_{X} or Q_{Y} direction. In such a case, the X component and the Y component of the tilt angle cannot be determined independently, but the X component and the Y component of the tilt angle can be determined using the loop analysis. The loop analysis can also be used at diffraction points with Q_{X}=0 nm⁻¹ or Q_{Y}=0 nm⁻¹, and many diffraction points can be used for the analysis.

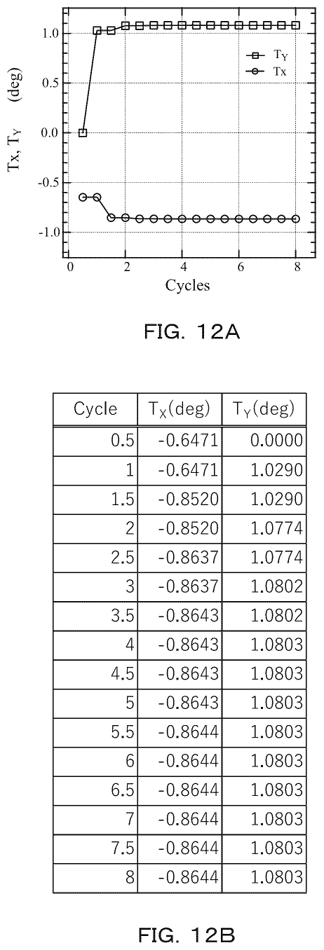

FIGS. 12A and 12B are a graph and a table showing optimize of XY components of the tilt, respectively. The respective peak positions of θ_{X} and θ_{Y} are expressed as T_{X} and T_{Y}. In the examples shown in FIGS. 12A and 12B, the numerical values converge by about four cycles of the loop analysis.

### Example 1

Examples are described below. First, as an application to the case where there is a Q_{Z} waveform with both Q_{X}=0 nm⁻¹ and Q_{Y}=0 nm⁻¹, the measurement was performed by rotating the silicon wafer sample 45° about an axis perpendicular to the wafer surface with respect to the notch and aligning an orientation of 45° with respect to the X-Y plane with the axis of ω rotation, and performing the ω rotation. Then, the tilt angle was calculated based on the obtained measurement data.

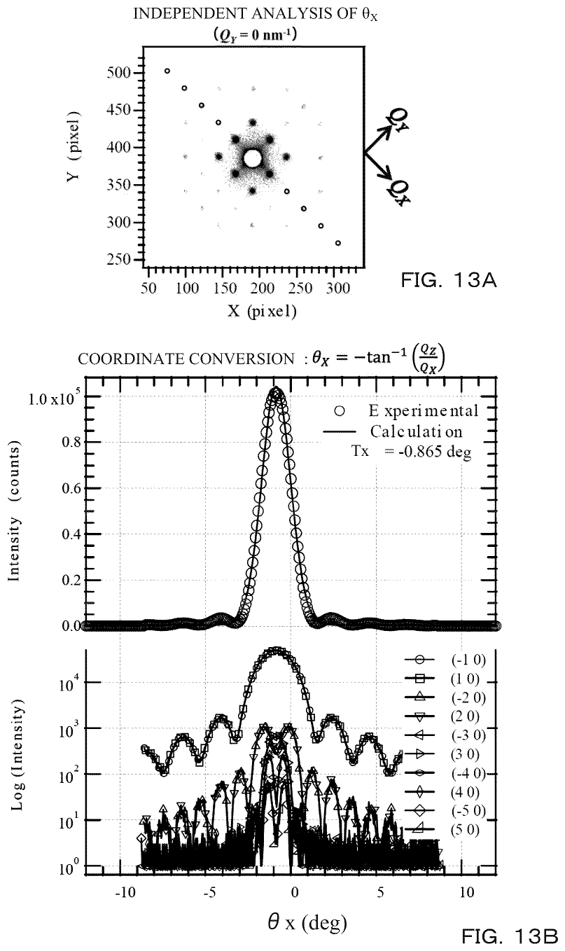

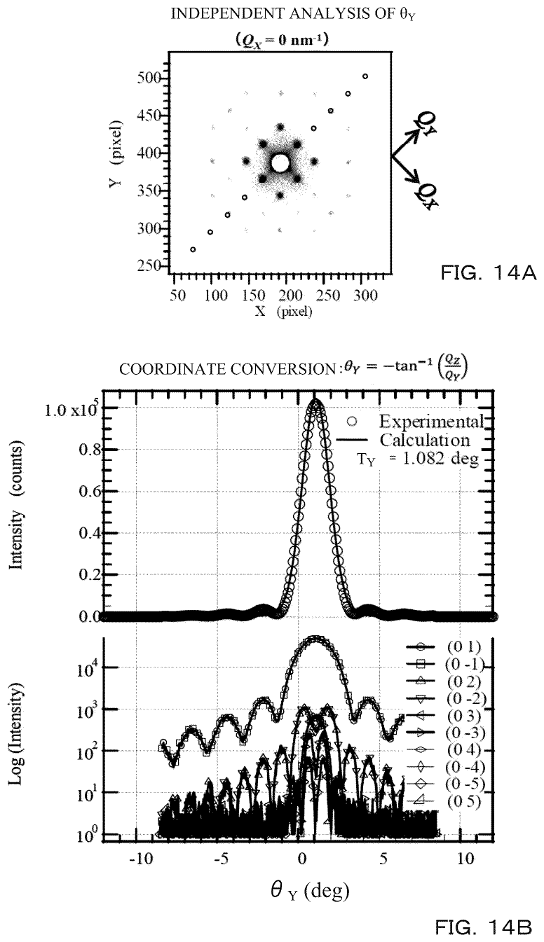

FIGS. 13A and 13B are a diffraction image subject to a single analysis of θ_{X} and a graph showing Q_{Z} waveforms based on the intensity for θ_{X} of diffraction points with Q_{Y}=0 nm⁻¹, respectively. FIGS. 14A and 14B are a diffraction image subject to a single analysis of θ_{Y} and a graph showing Q_{Z} waveforms based on the intensity for θ_{Y} of diffraction points with Q_{X}=0 nm⁻¹, respectively.

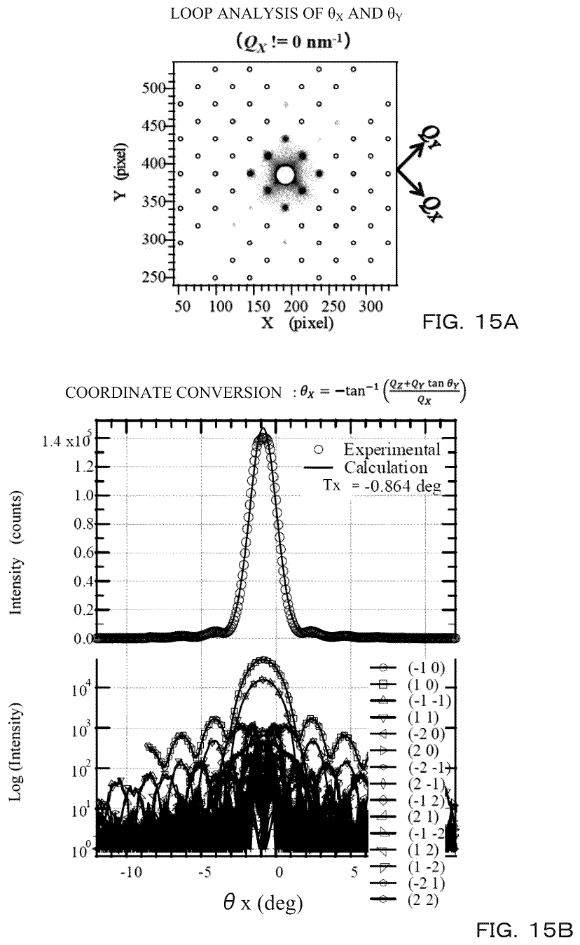

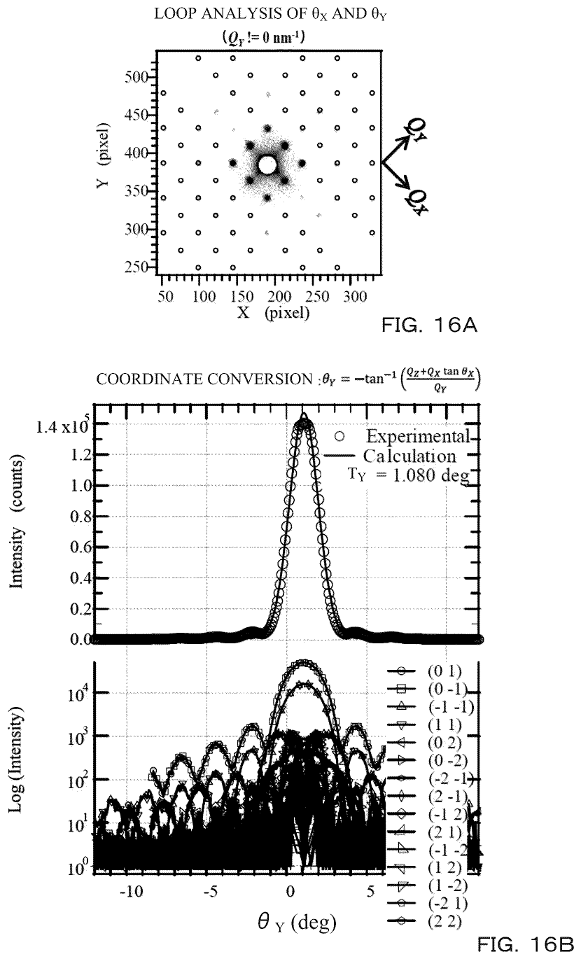

FIGS. 15A and 15B are a diffraction image subject to a loop analysis and a graph showing Q_{Z} waveforms based on the intensity for θ_{X} of diffraction points, respectively. FIGS. 16A and 16B are a diffraction image subject to a loop analysis and a graph showing Q_{Z} waveforms based on the intensity for θ_{Y} of diffraction points, respectively.

In the loop analysis, the numerical values converged by 4 cycles. FIG. 15B and FIG. 16B show Q_{Z} waveforms at 3.5th and 4the cycle, respectively. These are Q_{Z} waveforms at convergence. In the single analysis, −0.865 deg and 1.082 deg were obtained as the X component T_{X} of the tilt angle and the Y component T_{Y} of the tilt angle, respectively. In the loop analysis, −0.864 deg and 1.080 deg were obtained as the X component T_{X} of the tilt angle and the Y component T_{Y} of the tilt angle, respectively. Thus, analysis results coincided with each other with high accuracy.

### Example 2

Next, as an application example when there is no Q_{Z} waveform with either Q_{X}=0 nm⁻¹ or Q_{Y}=0 nm⁻¹, the silicon wafer sample was measured by rotating ω around the Y-axis (parallel to Q_{Y} axis) of the sample used in Example 1. Then, the tilt angle was calculated based on the acquired measurement data.

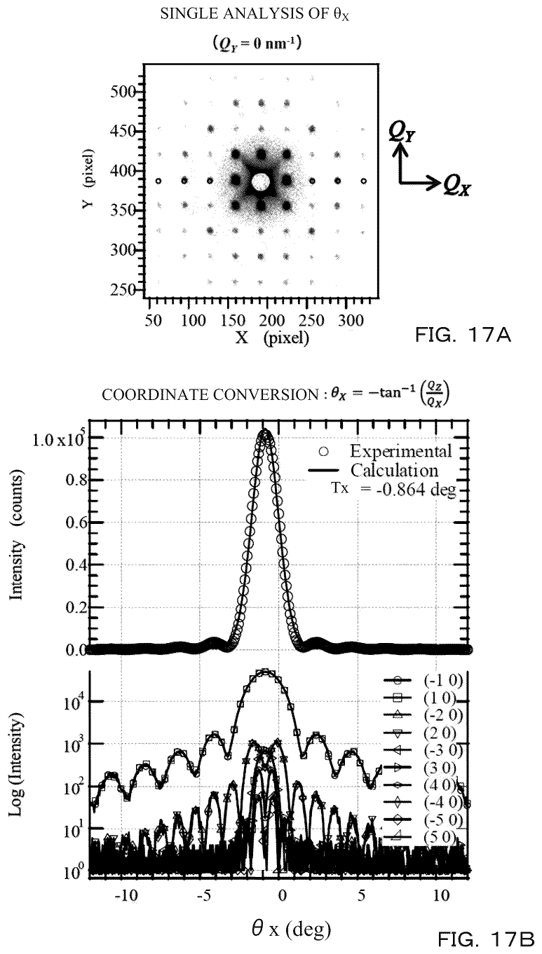

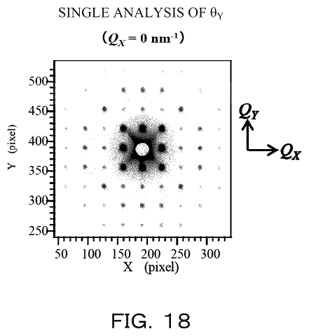

FIGS. 17A and 17B are a diffraction image subject to a single analysis of θ_{X} and a graph showing Q_{Z} waveforms based on the intensity for θ_{X} of diffraction points with Q_{Y}=0 nm⁻¹, respectively. FIG. 18 is a diffracted image subject to a single analysis of OY. Since the rotational axis coincides with Q_{Y} direction, Q_{Z} dependency of the diffracted point with Q_{X}=0 nm⁻¹ could not be obtained. Therefore, a single analysis of θ_{Y} was not possible.

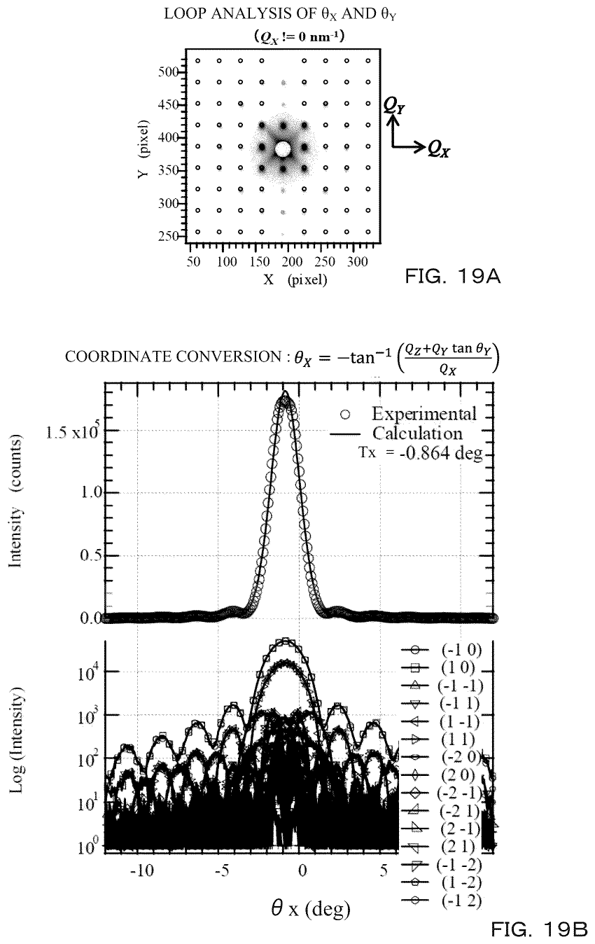

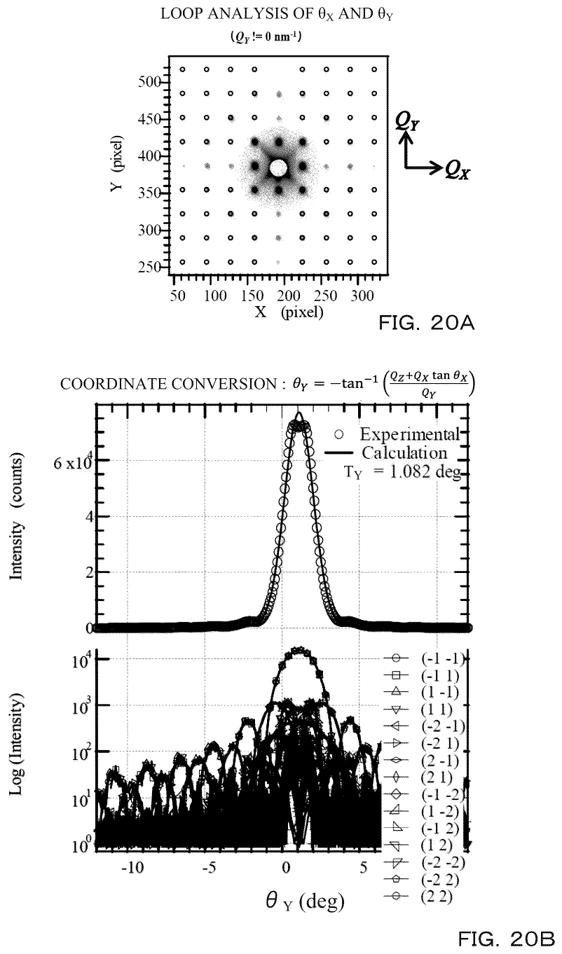

FIGS. 19A and 19B are a diffraction image subject to a loop analysis and a graph showing Q_{Z} waveforms based on the intensity for θ_{X} of diffraction points, respectively. FIGS. 20A and 20B are a diffraction image subject to a loop analysis and a graph showing Q_{Z} waveforms based on the intensity for θ_{Y} of diffraction points, respectively.

In the loop analysis, the numerical values converged by 4 cycles. FIG. 19B and FIG. 20B show Q_{Z} waveforms at 3.5th and 4th cycle, respectively. These are Q_{Z} waveforms at convergence. In the single analysis, −0.864 deg was obtained as the X-component T_{X} of the tilt angle. In the loop analysis, −0.864 deg and 1.082 deg were obtained as the X component T_{X} of the tilt angle and the Y component T_{Y} of the tilt angle, respectively. Thus, the X-components T_{X} of the tilt angle coincided with each other with high accuracy.

### Second Embodiment

The two-direction components need not necessarily be the X component and the Y component. As the two-direction components, parallel to the surface of the plate-shaped sample, a component in a₀ direction which is and is the scanning direction of ω-scanning and a component in a₁ direction orthogonal to a₀ direction can also be used. In this case, even when the orientation of the sample is not known, the tilt angle on the two components can be calculated based on the scan direction.

### (Single Analysis)

In this embodiment, a single analysis is possible. First, a₀ is independently determined by the following formula (10) using only the diffractive points of the scanning direction (θₕₖ=0, θₕₖ=π) with tanθₕₖ of 0. Note that ω0 is the rotational angle of the sample corresponding to Q_{Z}=0 nm⁻¹, and θₕₖ is the deflection angle of the diffracted point of the index (hk).

$${a}_{0} = ω - {ω}_{0} - {a}_{1} tan {θ}_{h k} \qquad ( 10 )$$

Next, a₁ is determined using formula (11).

$${a}_{1} = \frac{ω - {ω}_{0} - {a}_{0}}{tan {θ}_{hk}} \qquad ( 11 )$$

Here, when the diffraction points in the scanning direction (θₕₖ=0, θₕₖ=π) and the diffraction point in the direction perpendicular to the scanning direction (θₕₖ=±π/2) are selected, tanθₕₖ is 0 or diverges to infinity. Therefore, diffraction points other than the diffraction points in the scanning direction and the diffraction point in the direction orthogonal to the scanning direction are selected. The selected diffraction points are then used to determine a₁ using a₀ determined above. In this way, a₀ and a₁ can be determined as the components of the scanning direction for the tilt of the scattering body and the direction perpendicular to the scanning direction in a single time without looping.

Then, using formula (12) below, with regard to the peak positions of the converged a₀ and a₁, the components in a₀ and a₁ directions of the tilt angle are converted into the direction β determined by the notch on the silicon wafer sample.

$$\begin{matrix}{θ}_{X} = - {a}_{0} cos β - {a}_{1} sin β \\ {θ}_{Y} = - {a}_{0} sin β - {a}_{1} cos β\end{matrix} \qquad ( 12 )$$

### (Loop Analysis)

The following loop analysis is also possible. All diffraction points except the diffraction points (θₕₖ=±π/2) in the direction perpendicular to the scanning direction are used, an appropriate value (for example, 0) is given to a₁ as an initial value, and the peak position of a₀ is determined from Q_{Z} waveform performed the coordinate conversion by formula (10) using all diffraction points.

Further, based on Q_{Z} waveform performed the coordinate conversion by formula (11), all diffraction points except the diffraction points in the scanning direction (θₕₖ=0, θₕₖ=π) and the diffraction points in the direction perpendicular to the scanning direction (θₕₖ=±π/2) are used to determine the peak position of a₁ using a₀ determined above.

The calculation is repeated to determine the peak positions of a₀ and a₁ until the peak positions of a₀ and a₁ converge. Once the values converge, formula (12) is used to convert the components on a₀ and a₁ directions of the tilt angle into the components on a direction β that is determined by the notch on the silicon wafer sample with regard to the peak position of the converged a₀ and a₁.

### Example 3

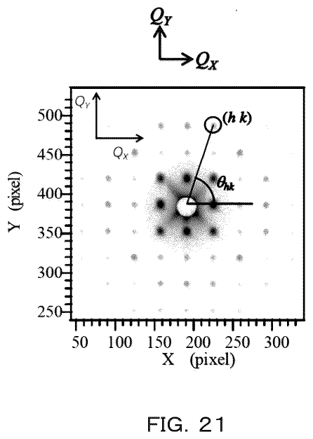

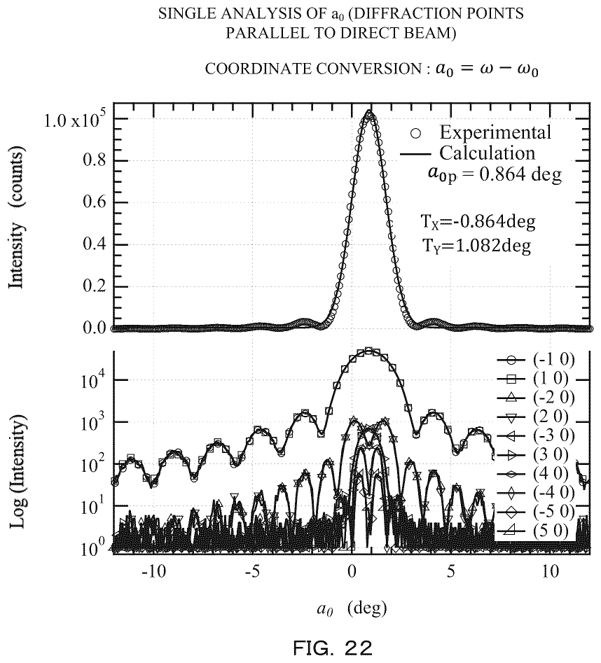

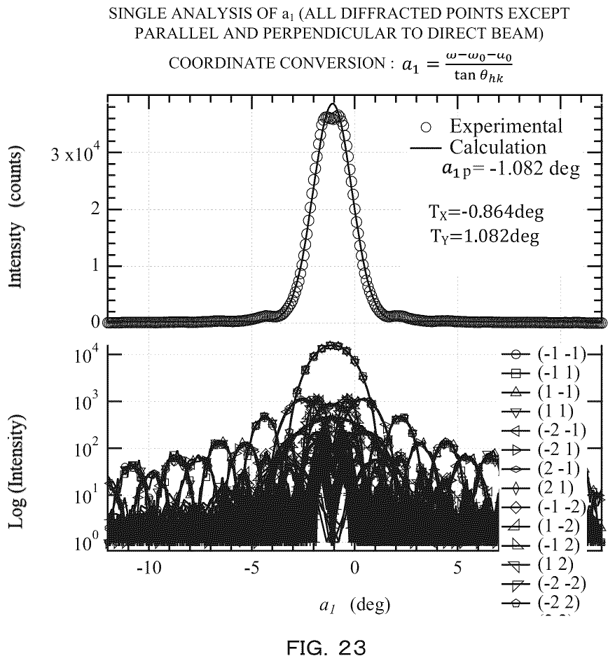

The sample used in Example 1 was subjected to a single analysis based on a₀ direction and a₁ direction. FIG. 21 is a diffraction image to be subjected to a single analysis. FIG. 22 are a diffraction image subject to a single analysis and a graph showing Q_{Z} waveforms based on the intensity for a₀ of diffraction points, respectively. FIG. 23 are a diffraction image subject to a single analysis and a graph showing Q_{Z} waveforms based on the intensity for a₁ of diffraction points, respectively. Note that a₀ₚ and a₁ₚ represent the peak positions of a₀ and a₁.

As the analysis result, −0.864 deg and 1.082 deg were obtained as T_{X} of the X component of the tilt angle and T_{Y} of the Y component of the tilt angle. The obtained results coincide with the results of Examples 1 and 2 with high accuracy.

### Example 4

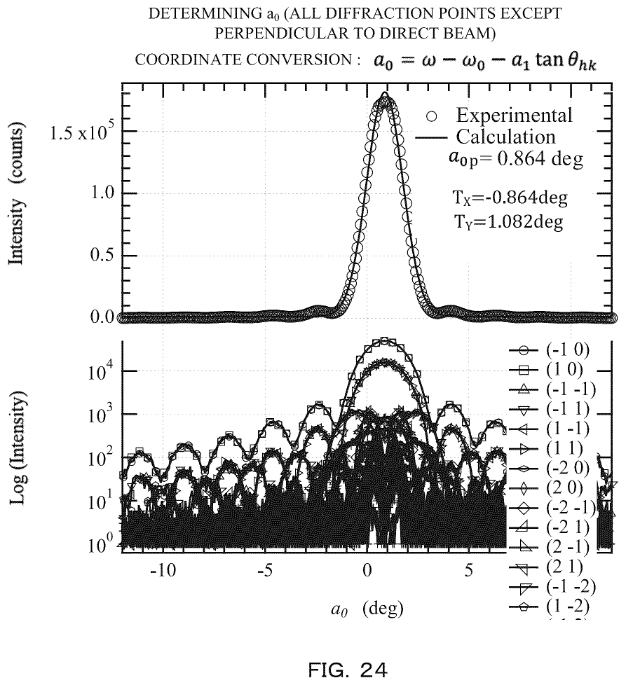

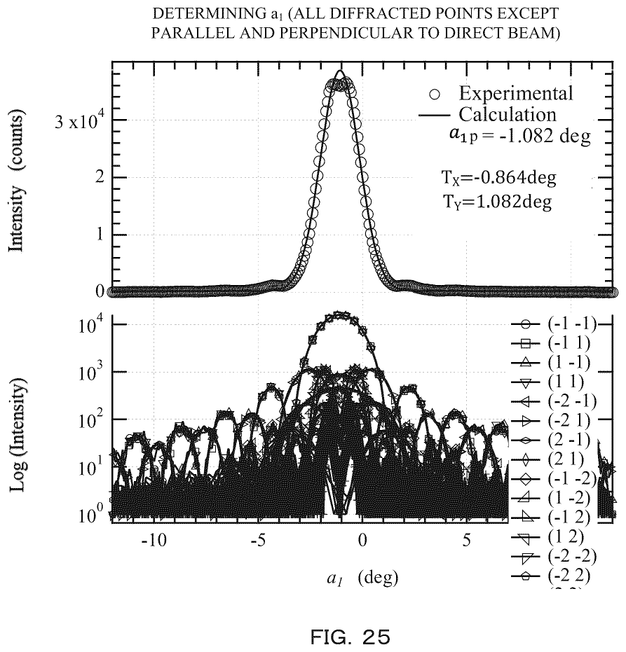

The sample used in Example 1 was subjected to the loop analysis based on a₀ and a₁ directions. The diffraction image to be subjected for the loop analysis is the same as the diffraction image to be subjected to the single analysis. FIG. 24 are a diffraction image subject to a loop analysis and a graph showing Q_{Z} waveforms based on the intensity for a₀ of diffraction points, respectively. FIG. 25 are a diffraction image subject to a loop analysis and a graph showing Q_{Z} waveforms based on the intensity for a₁ of diffraction points, respectively.

In the loop analysis, the numerical values converged by 4 cycles. FIG. 24 and FIG. 25 show Q_{Z} waveforms at 3.5th and 4the cycle, respectively. These are Q_{Z} waveforms at convergence. −0.864 deg and 1.082 deg were obtained as T_{X} of the X component of the tilt angle and T_{Y} of the Y component of the tilt angle. The obtained results coincide with the results of Examples 1 and 2 with high accuracy.

What is claimed is:

1. An analysis apparatus for analyzing a fine structure of a plate-shaped sample formed to have columnar scattering bodies that are long in a thickness direction and periodically arranged, comprising:
processing circuitry configured to
store data of a scattering intensity from the plate-shaped sample measured by transmission of X-rays in one ω scan,
perform coordinate conversion from the coordinate of the scattering vector to the coordinate of the tilt of the scattering body, with respect to a waveform based on an intensity of a specific diffraction point on the two-direction components, using the data of the measured scattering intensity,
specify a peak position of the waveform of the intensity with respect to the coordinate of the tilt applied the coordinate conversion, and
calculate a difference between the specified peak position and the peak position obtained on the assumption that the scattering body is not tilted from the direction perpendicular to the surface of the plate-shaped sample, on the two-direction components of the tilt of the scattering body.

2. The analysis apparatus according to claim 1, wherein the processing circuitry is further configured to
perform the coordinate conversion to the coordinate of the tilt of the scattering body on at least one of the two-direction components, by a single analysis using a diffraction point at which one of the two-direction components of the scattering vectors is 0.

3. The analysis apparatus according to claim 1, wherein the processing circuitry is further configured to
perform the coordinate conversion to the coordinate of the tilt of the scattering body on the two-direction components, by a loop analysis using a diffraction point where none of the two-direction components of the scattering vectors is not 0.

4. The analysis apparatus according to claim 1, wherein
the two-direction components correspond to components in X direction along with the unit cell and Y direction orthogonal to the X direction, both of the X and Y directions being parallel to the surface of the plate-shaped sample.

5. The analysis apparatus according to claim 1, wherein
components correspond to the two-direction components in a₀ direction and being the scanning direction of the ω-scan and a direction orthogonal to a₀ direction, both of the a₀ and a₁ directions being parallel to the surface of the plate-shaped sample.

6. The analysis apparatus according to claim 1, wherein the processing circuitry is further configured to
use a waveform integrated over a plurality of diffraction points as a waveform based on an intensity of a two-direction component of the specific diffraction point.

7. An analysis method for a fine structure of a plate-shaped sample formed to have columnar scattering bodies that are long in a thickness direction and periodically arranged, comprising:
preparing data of a scattering intensity from the plate-shaped sample measured by transmission of X-rays in one ω scan;
performing coordinate conversion from the coordinate of the scattering vector to the coordinate of the tilt of the scattering body, with respect to a waveform based on an intensity of a specific diffraction point on the two-direction components, using the data of the measured scattering intensity;
specifying a peak position of the waveform of the intensity with respect to the coordinate of the tilt applied the coordinate conversion; and
calculating a difference between the specified peak position and the peak position obtained on the assumption that the scattering body is not tilted from the direction perpendicular to the surface of the plate-shaped sample, on the two-direction components of the tilt of the scattering body.

8. A non-transitory computer readable recording medium having recorded thereon an analysis program for analyzing a fine structure of a plate-shaped sample formed to have columnar scattering bodies that are long in a thickness direction and periodically arranged, the program causing a computer to execute the following processes of:
preparing data of a scattering intensity from the plate-shaped sample measured by transmission of X-rays in one ω scan;
performing coordinate conversion from the coordinate of the scattering vector to the coordinate of the tilt of the scattering body, with respect to a waveform based on an intensity of a specific diffraction point on the two-direction components, using the data of the measured scattering intensity;
specifying a peak position of the waveform of the intensity with respect to the coordinate of the tilt applied the coordinate conversion; and
calculating a difference between the specified peak position and the peak position obtained on the assumption that the scattering body is not tilted from the direction perpendicular to the surface of the plate-shaped sample, on the two-direction components of the tilt of the scattering body.

9. The method of claim 7, further comprising:
performing the coordinate conversion to the coordinate of the tilt of the scattering body on at least one of the two-direction components, by a single analysis using a diffraction point at which one of the two-direction components of the scattering vectors is 0.

10. The method of claim 7, further comprising:
performing the coordinate conversion to the coordinate of the tilt of the scattering body on the two-direction components, by a loop analysis using a diffraction point where none e of the two-direction components of the scattering vectors is not 0.

11. The method of claim 7, wherein
the two-direction components correspond to components in X direction along with the unit cell and Y direction orthogonal to the X direction, both of the X and Y directions being parallel to the surface of the plate-shaped sample.

12. The method of claim 7, wherein
the two-direction components correspond to components in a₀ direction and being the scanning direction of the ω-scan and a₁ direction orthogonal to a₀ direction, both of the a₀ and a₁ directions being parallel to the surface of the plate-shaped sample.

13. The method of claim 7, further comprising:
using a waveform integrated over a plurality of diffraction points as a waveform based on an intensity of a two-direction component of the specific diffraction point.

14. The non-transitory computer readable recording medium of claim 8, further comprising:
performing the coordinate conversion to the coordinate of the tilt of the scattering body on at least one of the two-direction components, by a single analysis using a diffraction point at which one of the two-direction components of the scattering vectors is 0.

15. The non-transitory computer readable recording medium of claim 8, further comprising:
performing the coordinate conversion to the coordinate of the tilt of the scattering body on the two-direction components, by a loop analysis using a diffraction point where none of the two-direction components of the scattering vectors is not 0.

16. The non-transitory computer readable recording medium of claim 8, wherein
the two-direction components correspond to components in X direction along with the unit cell and Y direction orthogonal to the X direction, both of the X and Y directions being parallel to the surface of the plate-shaped sample.

17. The non-transitory computer readable recording medium of claim 8, wherein
the two-direction components correspond to components in a₀ direction and being the scanning direction of the ω-scan and a₁ direction orthogonal to a₀ direction, both of the a₀ and a₁ directions being parallel to the surface of the plate-shaped sample.

18. The non-transitory computer readable recording medium of claim 8, further comprising:
using a waveform integrated over a plurality of diffraction points as a waveform based on an intensity of a two-direction component of the specific diffraction point.
